(19) United States
(12) Patent Application Publication
(10) Pub. No.: US 2024/0265433 A1
(43) Pub. Date: Aug. 8, 2024

(54) INTERACTIVE SYSTEM AND METHOD FOR RECOMMENDING ONE OR MORE LIFESTYLE PRODUCTS

(71) Applicant: Modaviti eMarketing Private Limited, Mumbai (IN)

(72) Inventors: Manoj Shinde, Mumbai (IN); MD Danish Jamil, Mumbai (IN); Abhit Sinha, Noida (IN)

(21) Appl. No.: 18/430,345

(22) Filed: Feb. 1, 2024

(30) Foreign Application Priority Data
Feb. 2, 2023 (IN) 202321006770

(51) Int. Cl. G06Q 30/0601; G06T 19/00; G06V 10/143; G06V 10/82; G06V 40/16

(52) U.S. Cl. CPC G06Q 30/0631; G06T 19/006; G06V 10/143; G06V 10/82; G06V 40/166; G06V 40/171

(57) ABSTRACT

An interactive system, comprising a mirror device that comprises a mirror surface. The mirror device is configured to present a reflection of a body portion of a user on the mirror surface, where the body portion comprises a facial portion. The mirror device is configured to determine a plurality of facial attributes of the user based on the reflection of the body portion of the user, determine a plurality of environmental parameters in nearby surroundings of the user, and present a modified reflection of the body portion of the user on the mirror surface along with one or more lifestyle products based on the determined plurality of facial attributes and the determined plurality of environmental parameters. The interactive system comprise a dispensing system configured to dispense out at least one lifestyle product of the one or more lifestyle products based on the presented modified reflection on the mirror device.

### CROSS-REFERENCE TO RELATED APPLICATIONS/INCORPORATION BY REFERENCE

This Patent Application makes reference to, claims the benefit of, and claims priority to an Indian Provisional Patent Application Ser. No. 20/232,1006770, filed on Feb. 2, 2023, which is incorporated herein by reference in its entirely, and for which priority is hereby claimed under the Paris Convention and 35 U.S.C. 119 and all other applicable law.

### FIELD OF TECHNOLOGY

Certain embodiments of the disclosure relate to vending machines and systems. More specifically, certain embodiments of the disclosure relate to an interactive system, and a method for recommending one or more lifestyle products.

### BACKGROUND

Conventionally, in an implementation scenario, a display system is attached to a vending machine, which allows a user to select a lifestyle product(s) (including beauty and personal care products) comprised by the vending machine and get the selected lifestyle product(s) either by pressing a key of a keyboard or by use of a touch board attached to the display system. In such an implementation scenario, the display system displays the lifestyle products about which the user is already aware. Also, the display system enables a selection of lifestyle products, and the vending machine provides the selected lifestyle product to the user on the go. However, such an arrangement of the display system and the vending machine lacks in the recommendation of any beauty product or the lifestyle product to the user based on health analysis, including skin features, facial attributes, and environmental implications on the face of the user.

In another implementation scenario, the display system and the vending machine are used individually for the distribution of lifestyle products. In this implementation scenario, the display system merely displays the lifestyle products to the user and lacks in dispensing out the lifestyle products to the user. The vending machine can only dispense lifestyle products and lacks a display of the lifestyle products to the user. Thus, there exists a technical problem of how efficiently a user can obtain reliable lifestyle products according to his/her health parameters, including facial structure, facial attributes, eye color, hair color, hair style, and derma parameters, such as skin attributes, dullness of skin, skin texture, acne, dark spots, derma qualities, and external environmental parameters including weather of a particular region, pollution and UV index, age and gender, and the like.

Further limitations and disadvantages of conventional and traditional approaches will become apparent to one of skill in the art through comparison of such systems with some aspects of the present disclosure as set forth in the remainder of the present application with reference to the drawings.

### BRIEF SUMMARY OF THE DISCLOSURE

An interactive system and a method for recommending one or more lifestyle products to a user, substantially as shown in and/or described in connection with at least one of the figures, as set forth more completely in the claims. The disclosed interactive system and method recommend the one or more lifestyle products (including beauty and personal care products) with enhanced reliability by analyzing the health parameters of the user, such as facial attributes, an eye color, a hair color, a hair style, skin attributes, including skin texture of the user, acne, dark spots, etc., and also, analyzing the impact of environmental parameters on the health of the user, such as weather of a particular region, Ultra-Violet (UV) index, pollution index, and the like.

These and other advantages, aspects, and novel features of the present disclosure, as well as details of an illustrated embodiment thereof, will be more fully understood from the following description and drawings.

### BRIEF DESCRIPTION OF DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1A is a block diagram of an interactive system for recommending one or more lifestyle products to a user, in accordance with an embodiment of the present disclosure;

FIG. 1B is a diagram illustrating various exemplary components of a mirror device, in accordance with an embodiment of the present disclosure;

FIG. 1C is a network environment diagram of an interactive system, in accordance with an embodiment of the present disclosure;

FIG. 2 is a diagram illustrating an exemplary implementation scenario of an interactive system, in accordance with an embodiment of the present disclosure;

FIG. 3 is a diagram illustrating an integration of an interactive system with an eyewear recommendation system, in accordance with an embodiment of the present disclosure;

FIG. 4 is a diagram illustrating an integration of an interactive system with a dynamic product formulation system, in accordance with an embodiment of the present disclosure;

FIG. 5 is a diagram illustrating an integration of an interactive system with a physical try-on unit, in accordance with an embodiment of the present disclosure; and

FIG. 6 is a diagram illustrating a flowchart of a method for recommending one or more lifestyle products, in accordance with an embodiment of the present disclosure.

### DETAILED DESCRIPTION OF THE DISCLOSURE

Certain embodiments of the disclosure may be found in an interactive system, and a method for recommending one or more lifestyle products to a user. The disclosed interactive system and method not only recommend the one or more lifestyle products to the user with reliability but also allow the user to dispense out the recommended lifestyle products through the dispensing system simultaneously. The interactive system and method enable an intelligent interaction of the user with the mirror device in which the user can virtually try different hair colors, hair styles, different eye frames, or makeup products by themselves and get the recommendation of the best suitable lifestyle product. Moreover, the interactive system is configured to analyze the facial skin of the user and provide strengths and weaknesses of the facial skin in a quantified manner to the user. Based on the provided negative annotation and the quantified score of the aforementioned parameters, the interactive system and method provide a unique skin regime or routine, which may comprise one or more positive, neutral as well as negative impact on the user's skin, to the user. Additionally, the interactive system may also be referred to as a human-less store and can be placed in public places, such as shopping malls, public transportation terminals, hotels, amusement parks, and the like. Such placement of the interactive system enables the user (or users) to virtually try several lifestyle products, including beauty and personal care products, without any physical assistance and to utilize a waiting period to experience the personalized journey. Also, the user may get personalized free samples of the lifestyle products, including beauty and personal care products, or buy the lifestyle products, including beauty and personal care products, using self-checkout, resulting in a reduced overhead cost of manpower as well. The interactive system provides an expert-assisted virtual try-on experience of skin and hair care products, where the user can virtually connect with available experts, and based on the expert recommendations, the user may get personalized look recommendations. This way, the interactive system provides a user-friendly experience and reliable recommendations for lifestyle products, including beauty and personal care products, which brings the users closer to a specific brand, resulting in an impulsive growth of the specific brand value.

In the following description, reference is made to the accompanying drawings, which form a part hereof, and in which is shown, by way of illustration, various embodiments of the present disclosure.

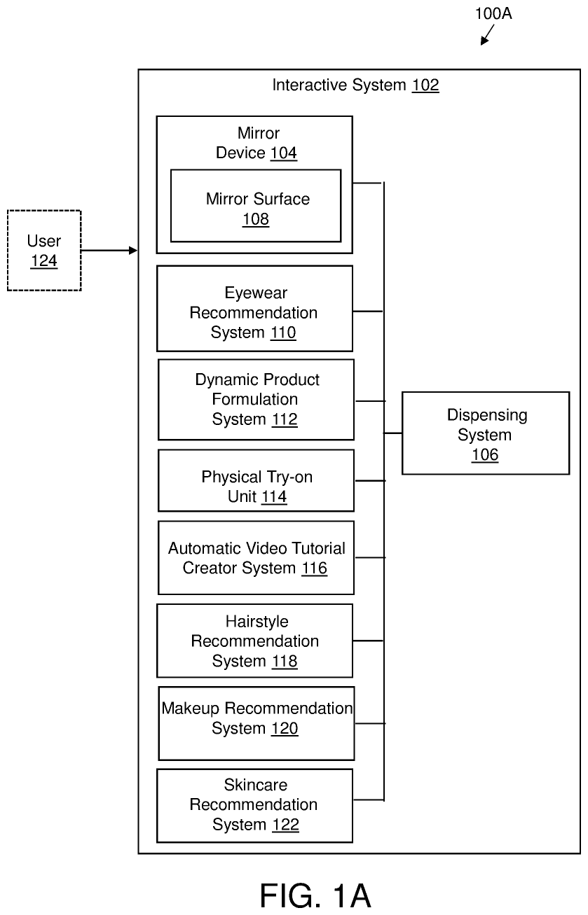

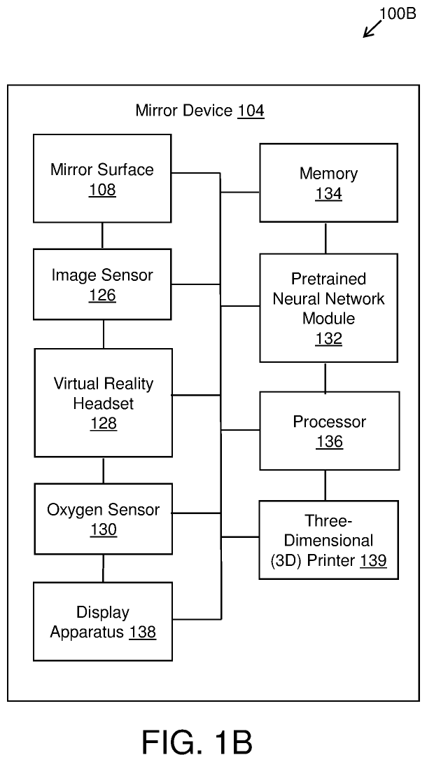

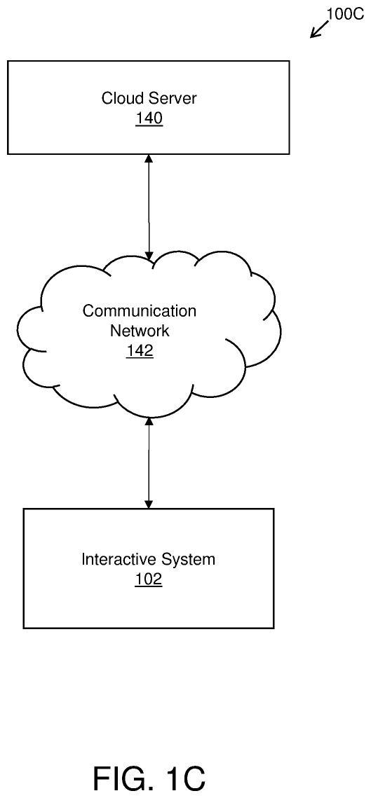

FIG. 1A is a diagram illustrating various exemplary components of an interactive system, in accordance with an embodiment of the present disclosure. With reference to FIG. 1A, there is shown a block diagram 100A of an interactive system 102 that may include a mirror device 104 and a dispensing system 106. The mirror device 104 may comprise a mirror surface 108. The interactive system 102 may further include an eyewear recommendation system 110, a dynamic product formulation system 112, a physical try-on unit 114, an automatic video tutorial creator system 116, a hairstyle recommendation system 118, a makeup recommendation system 120 and a skincare recommendation system 122. There may be further shown a user 124.

The interactive system 102 may be referred to as a computer-based setup that allows the user 124 to engage in real-time communication, exchange information, and interact with digital content through various input and output devices. The interactive system 102 may be used for recommending one or more lifestyle products, including beauty and personal care products to the user 124. The one or more lifestyle products may be related to skin, hair, eye, lip, nose, nail, forehead and neck length, and the like. Alternatively, the interactive system 102 may also be stated as an Artificial Intelligence (AI) based lifestyle products recommendation system including beauty and personal care products to the user 124 by analyzing one or more health parameters of the user 124 and external environmental parameters in nearby surroundings of the user 124. The health parameters may include facial structure, facial attributes, eye color, hair color, hair style, and derma parameters of the user 124, such as skin attributes, dullness of skin, skin texture, acne, dark spots, and the like. The external environmental parameters may include weather of a particular region, pollution, Ultra-Violet (UV) index, age and gender of the user 124, and the like.

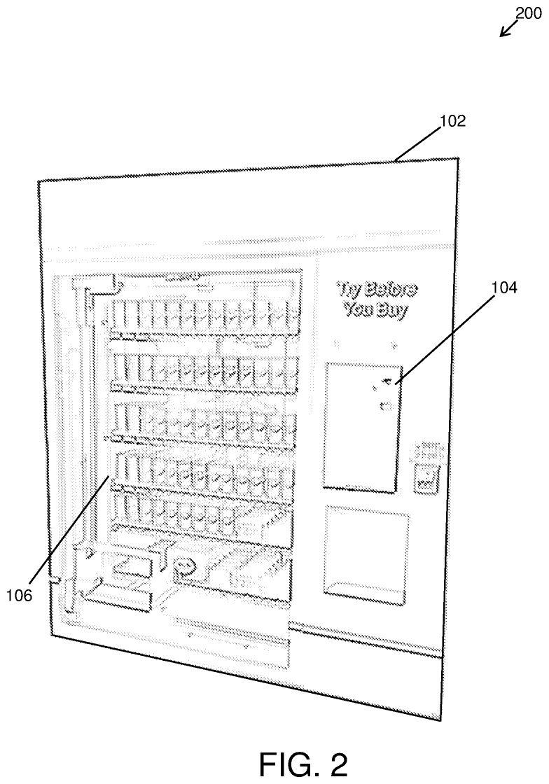

The interactive system 102 may also be referred to as an automated one-stop platform (e.g., a human-less store system) where the user 124 can virtually try different lifestyle products, including beauty and personal care products related to skin care, hair style, or hair color, and the like. By use of the interactive system 102, the user 124 may try different hair styles, different hair colors, and different cosmetic products, such as different foundation shades, different lip colors, different eye colors, and the like. Moreover, the user 124 may watch tutorials on how to use various lifestyle products and may get a three-dimensional (3D) sample of eyewear frames. Further, the user 124 may get personalized samples of cosmetic products and purchase the product with self-checkout. The interactive system 102 may also be referred to as an Augmented Reality (AR) kiosk with a Virtual Reality (VR) playground having following features, such as virtual makeup try-on experience of beauty and skin care products, virtual hair color, virtual hairstyle, AI skin analysis, beauty product recommendations, product tutorials using a VR headset, online expert assistance, product sampling, 3D printing of a product, product dispensing through the dispensing system 106, self-checkout, and the like. An exemplary implementation scenario of the interactive system 102 is shown and described, for example, in FIG. 2.

The mirror device 104 may be referred to as a display device that is configured to utilize reflective surfaces or technologies to project visual information, such as images or text, onto a reflective surface, enabling the user 124 to view the content as if it is displayed directly on a mirror-like surface. The mirror device 104 may comprise the mirror surface 108, which is configured to serve as a primary interface for the user 124 to interact with a machine-learning experience provided by the mirror device 104. By incorporating the mirror surface 108, the user 124 can seamlessly integrate the machine learning capabilities into their daily routines. The mirror surface 108 enables the user 124 to receive real-time personalized information, such as weather updates, news, and health metrics, through a visually appealing and familiar medium.

The dispensing system 106 may be referred to as either a mechanism or an apparatus designed to dispense out a product in a controlled manner, typically through the use of pumps, nozzles, or other similar components. The dispensing system 106 may offer multiple options for product delivery, including a vending system, a 3D printer, or a lip bar. By integrating either the vending system or the 3D printer of the lip bar with the dispensing system 106, the dispensing system 106 enables the user 124 to conveniently access and acquire personalized beauty products, revolutionizing the way beauty products are dispensed and enhancing the overall user experience.

In operation, the mirror device 104 is configured to present a reflection of a body portion of the user 124 on the mirror surface 108, wherein the body portion comprises a facial portion. For example, when the user 124 visits the interactive system 102 (i.e., the human-less store), and the user 124 uses the mirror device 104, the mirror surface 108 comprised by the mirror device 104 presents the reflection of the body portion of the user 124 when the user 124 comes in front of the mirror surface 108. The body portion of the user 124 includes the facial portion, which includes various pointers, such as hair, eyes, lips, and cheeks of the user 124. The primary function of the mirror device 104 is to capture a frontal selfie of the user's face (i.e., the face of the user 124) and to process and enhance the required image information in order to present an accurate representation of the facial portion of the user 124. The mirror device 104 enables the user 124 to conveniently view and assess the facial appearance in real-time or near real-time, similar to a mobile phone but with a larger form factor. The various exemplary components of the mirror device 104 are shown and described, for example, in FIG. 1B.

The mirror device 104 is further configured to determine a plurality of facial attributes of the user 124 based on the reflection of the body portion of the user 124. After presenting the reflection of the body portion (more specifically, the facial portion) of the user 124 on the mirror surface 108, the mirror device 104 is configured to analyze the facial attributes of the user 124. The facial attributes may include skin concerns, such as wrinkles, eye bags, crows-feet, redness, uneven skin, dryness of skin, flaky skin, and the like. The facial attributes may also include the hair textures of the user 124. In an implementation, the mirror device 104 may be configured to take a selfie of the user 124 and determine the skin parameters of the user 124.

In accordance with an embodiment, the plurality of facial attributes comprises two or more of: a face shape, one or more skin attributes, a hairstyle, a unique user-specific eye shape, a user-specific eye size, a user-specific nose shape, a nose type, and a facial jawline. The plurality of facial attributes collectively contributes to the overall appearance and aesthetics of the user's face (i.e., the face of the user 124). By considering the interrelation between the plurality of facial attributes, a comprehensive classification of nose shapes and styles, eye sizes and shapes, the facial jawline, face shapes and sizes, and the like can be obtained, which may be further used as a valuable tool for cosmetic professionals and individuals who are seeking of personalized facial enhancements.

In accordance with an embodiment, the mirror device 104 is further configured to detect a nose type and a corresponding impact indicator of the detected nose type on selection of the one or more lifestyle products, and the plurality of facial attributes further comprises the detected nose type and the corresponding impact indicator. This feature allows the mirror device 104 to interact with the user's nose (i.e., the nose of the user 124), analyze its unique characteristics, and provide valuable information to the user 124 for choosing a suitable eyewear. By accurately detecting the nose type and its impact on the eyewear selection, the mirror device 104 enhances the user's ability to make informed decisions, ensuring a more comfortable and aesthetically pleasing experience. The detected nose type, in conjunction with the impact indicator, plays a significant role in determining the aesthetic impact of the nose on the overall facial appearance of the user 124. By analyzing and categorizing different nose types, a comprehensive understanding of how different nose shapes and styles influence the overall facial aesthetics can be obtained. This information is valuable for various applications, such as cosmetic surgery, facial recognition technology, and virtual avatar creation. The interrelation between the detected nose type and the impact indicator ensures an accurate classification and provides insights into the visual impact of the nose, thereby enhancing the functionality and practicality of the interactive system 102.

The mirror device 104 is further configured to determine a plurality of environmental parameters in nearby surroundings of the user 124. The mirror device 104 is further configured to determine the plurality of environmental parameters, such as a pollution index, a UV index (i.e., high temp), humidity, and the like, in the proximity of the user 124.

In accordance with an embodiment, the plurality of environmental parameters comprises one or more of: a weather in a geographical location of the mirror device 104, a pollution level, an Ultraviolet (UV) index, a time of the day, and a humidity level of the geographical location. The environmental parameters play a significant role in determining the appropriate skincare products and routines for the user 124. The determination of the facial attributes of the user 124, along with the determination of the environmental parameters in nearby surroundings of the user 124, ensures that the recommended one or more lifestyle products including beauty and skincare products meet the user's individual requirements and enhance the effectiveness and relevance of the recommended product.

The mirror device 104 is further configured to present a modified reflection of the body portion of the user 124 on the mirror surface 108, along with the one or more lifestyle products based on the determined plurality of facial attributes and the determined plurality of environmental parameters. The determined facial attributes of the user 124 and the external environmental parameters in nearby surroundings of the user 124 are analyzed collectively along with consideration of any allergy of the user 124 towards certain chemicals, such as paraben or sulphate, and the like. Based on the collective analysis, the mirror device 104 is further configured to recommend a lifestyle product or a personal care product to the user 124 and generate the modified reflection of the body portion of the user 124 along with the recommended lifestyle product. This is advantageous to present the modified reflection of the body portion of the user 124 along with the recommended lifestyle product in order to enhance the user's beauty routine by providing the user 124 a comprehensive understanding of his/her skin needs and the environmental factors that may impact the skin attributes of the user 124. The mirror device 104 may also be referred to as a recommendation system that recommends the most suitable product (related to any beauty, personal care or lifestyle) to the user 124 based on the determined facial attributes of the user 124 and the determined environmental parameters.

In accordance with an embodiment, the modified reflection comprises at least a change in a facial feature of the user 124 when the one or more lifestyle products are to be used by the user 124. By incorporating the modified reflection, the mirror device 104 may provide a realistic representation of how the recommended lifestyle product would affect the user's appearance. The modified reflection may comprise either a change in the hair style of the user 124, a change in the hair color of the user 124, a change in an eyewear frame worn by the user 124, or a change in foundation shade applied on the user's face, and the like. The interaction between the modified reflection and the mirror device 104 enables the user 124 to visualize the potential outcomes of using the recommended product and thereby improving the decision-making process of the mirror device 104 (i.e., the recommendation system) as well as enhances the user's satisfaction and makes the mirror device 104 a valuable component of the interactive system 102 (i.e., the human-less store system).

The interactive system 102 further comprises the dispensing system 106 connected to the mirror device 104 configured to dispense out at least one lifestyle product of the one or more lifestyle products based on the presented modified reflection on the mirror device 104. After getting a recommendation of the most suitable product (related to any beauty, personal care, or lifestyle) from the mirror device 104, the user 124 is allowed to obtain the recommended product from the dispensing system 106 connected to the mirror device 104.

In accordance with an embodiment, the dispense out of the at least one lifestyle product is performed automatically in response to a user confirmation on the presented modified reflection uniquely attuned to the plurality of facial attributes and the plurality of environmental parameters. When the user 124 provides the confirmation on the presented modified reflection to the mirror device 104, the dispensing system 106 may be configured to dispense out the recommended product. This feature is achieved through the interaction of the mirror device 104 (i.e., the recommendation system), which analyzes the user's facial attributes and environmental parameters, and the dispensing system 106, which dispenses the recommended beauty product. By combining these entities, the user 124 is allowed to receive not only the personalized beauty product recommendations but also the recommended product from the dispensing system 106 without any manual intervention. This automated process not only reduces installation and operational costs but also enhances the overall brand experience for the user 124.

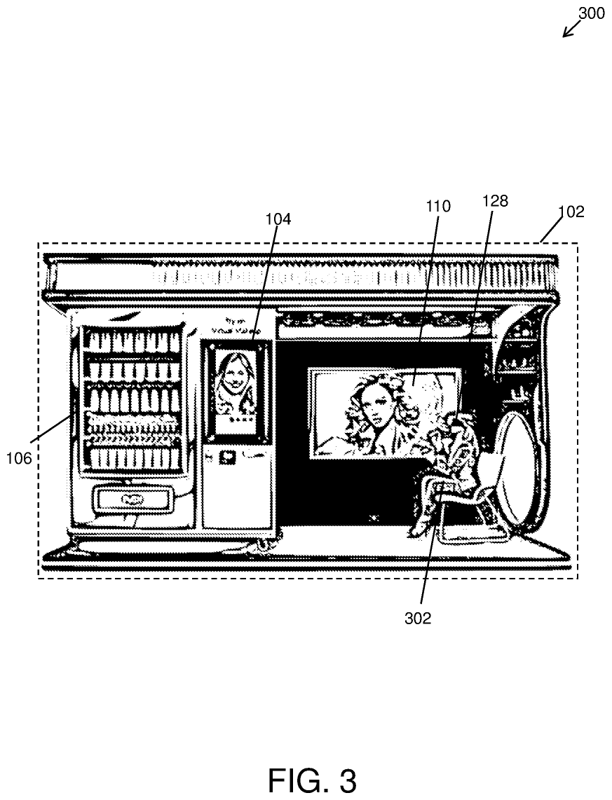

In accordance with an embodiment, the interactive system 102 further comprises the eyewear recommendation system 110 configured to recommend a three-dimensional (3D) eyewear frame to the user 124 based on an emotional index of the user 124, gaze metrics of the user 124, a facial jawline of the user 124, an eye shape, a type of nose of the user 124, a context communicated by the user 124, an intent and preferences of the user 124, wherein the recommended 3D eyewear frame is provided to the user 124 in a physical form. The eyewear recommendation system 110 may be referred to as a computer-based system that utilizes algorithms and data analysis techniques to provide personalized recommendations for eyewear products based on user preferences, facial features, and other relevant factors. The 3D eyewear frame may be referred to as an eyewear frame that is designed and manufactured using three-dimensional modeling and printing techniques, resulting in a frame with enhanced customization options, improved fit, and increased comfort for the wearer. The eyewear recommendation system 110 interacts with the user's emotional index, which is a measure of the emotional state or preferences of the user 124, to determine the most suitable eyewear frame. Moreover, the eyewear recommendation system 110 considers the gaze metrics of the user 124, the facial jawline of the user 124, the eye shape and the type of nose of the user 124 to determine the most suitable eyewear frame for the user 124. By analyzing the emotional index, gaze metrics, the facial jawline, the eye shape and the type of nose of the user 124, the eyewear recommendation system 110 can identify the user's emotional needs and preferences and, thereby, recommend eyewear frames that align with the emotional state as well as lifestyle and preferences of the user 124. This personalized recommendation process enhances the user's overall experience by ensuring that the recommended eyewear frames are well-suited to the emotional needs, resulting in an increased user satisfaction and engagement with the eyewear. An exemplary implementation scenario of the eyewear recommendation system 110 is shown and described in detail, for example, in FIG. 3.

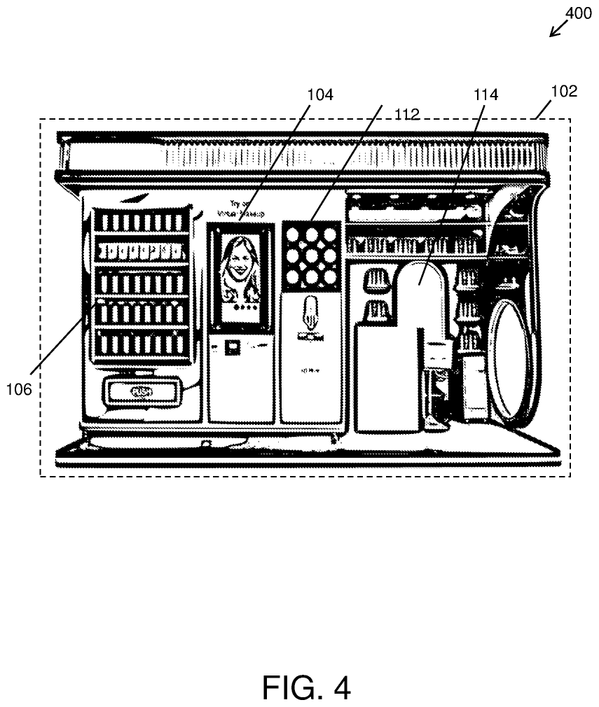

In accordance with an embodiment, the interactive system 102 further comprises the dynamic product formulation system 112 configured to formulate in a real-time or near real-time a customized product and dispense out the formulated customized product for the user 124 based on an analysis of a plurality of physiological parameters and an activity level of the user 124. The dynamic product formulation system 112 may be referred to as a system that enables the real-time adjustment and modification of product formulations based on various factors such as customer preferences, market trends, ingredient availability, and regulatory requirements. An example of the dynamic product formulation system 112 may be a smart lipstick dispenser, which may be configured to formulate a lipstick in real-time or near real-time according to the user 124 requirements. An exemplary implementation scenario of the dynamic product formulation system 112 is shown and described in detail, for example, in FIG. 4. The dynamic product formulation system 112 operates by analyzing the plurality of physiological parameters and the user's activity level. The dynamic product formulation system 112 may incorporate a carefully curated user input questionnaire that dynamically updates each individual user experience. This questionnaire includes pre-analysis questions, such as gender and age, which provide a baseline for contextualizing the outcomes of the dynamic product formulation system 112 and enhancing the understanding of the user's skin parameters. By considering these factors, the dynamic product formulation system 112 is able to formulate a customized product (e.g., a lipstick) that meets the specific needs of the user 124, resulting in an improved user experience and optimized product performance.

In accordance with an embodiment, the dynamic product formulation system 112 is equipped with a sensing device to measure the plurality of physiological parameters and the activity level of the user 124, wherein the plurality of physiological parameters comprises a heart rate, a skin tone, a skin color, a skin temperature, and an emotion index. The dynamic product formulation system 112 may be equipped with a small sensor (e.g., Remote Photoplethysmography, RPPG) which is configured to communicate with the user 124 smartphone and analyze the behavior of the user 124 based on physiological parameters, such as the heart rate, the skin tone, the skin color, the skin temperature, the emotion index, the lip style detector, and the like. The facial expressions and voice of the user 124 are also analyzed to determine the user's stress and emotion levels. This information is required for assessing the user's skin health, as it supports identifying various skin indicators like skin dullness, uneven skin tone, stress marks, early wrinkles, and under-eye circles. Based on the determined physiological parameters and skin health of the user 124, the dynamic product formulation system 112 suggests appropriate skincare routines for the user 124. Moreover, the dynamic product formulation system 112 considers the time of the day, external weather as well as activity information of the user 124 to dispense out the formulated product. Consequently, the dynamic product formulation system 112 may be configured to adjust the color of the formulated product (i.e., the lipstick) and, accordingly, provide a unique and personalized experience to the user 124.

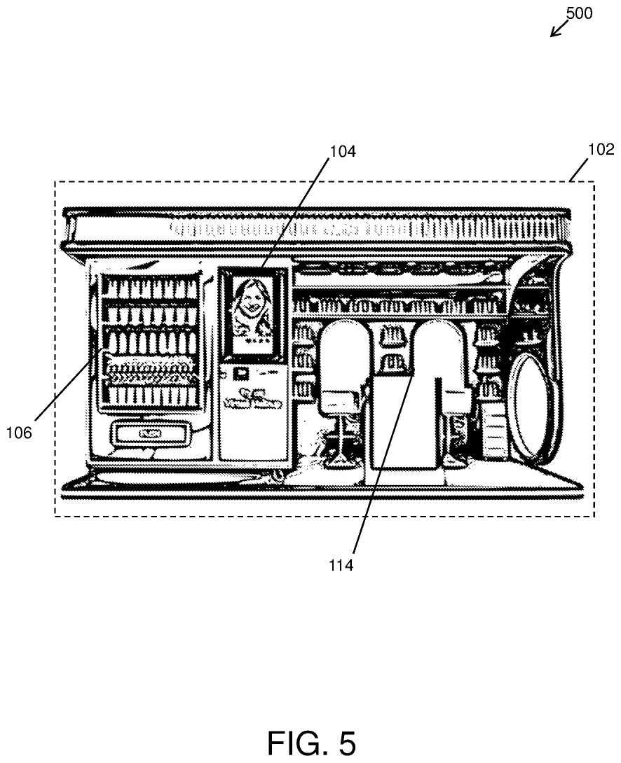

In accordance with an embodiment, the interactive system 102 further comprises the physical try-on unit 114 configured to form a user-specific visualization indicative of a lifestyle product visually discernible to be worn by the user 124 or applied to a body portion of the user 124 depending on a type of lifestyle product on the physical try-on unit 114. The physical try-on unit 114 may allow the user 124 to physically try on or test various products, including beauty, lifestyle, or personal care products (e.g., an eyewear), in order to assess product fitness, product comfort, and overall suitability before making a purchase decision. In an implementation scenario, the physical try-on unit 114 may interact with a virtual platform and a deep skin analysis system to provide a comprehensive and tailored product purchase journey. By utilizing advanced technologies like Augmented Reality (AR) and Virtual Reality (VR), the physical try-on unit 114 enables the user 124 to virtually try on different products, receive expert recommendations, and even, to get the sample print of the recommended 3D eyewear frames. An exemplary implementation scenario of the physical try-on unit 114 is shown and described in detail, for example, in FIG. 5. Thus, the use of the physical try-on unit 114 enhances the ability of the user 124 to make informed purchasing decisions and, ultimately improves the overall shopping experience of the user 124.

In accordance with an embodiment, the interactive system 102 further comprises the automatic video tutorial creator system 116 configured to generate instructional videos from a series of images that depict a step-by-step process for using the one or more lifestyle products. The automatic video tutorial creator system 116 may be referred to as a computer-based system that is capable of generating instructional videos without human intervention, utilizing algorithms and predefined templates to automatically capture, edit, and compile visual and audio content, thereby facilitating the creation of educational or instructional materials in a streamlined and efficient manner. The automatic video tutorial creator system 116 may be configured to utilize computer vision and image processing techniques to analyze the images and detect changes between each step. By combining the images together, the automatic video tutorial creator system 116 creates a smooth, animated video that visually demonstrates the active process. The resulting instructional videos are easy for viewers to understand and follow, making them suitable for a variety of industries, including DIY, beauty, cooking, and more. The automatic video tutorial creator system 116 interacts with the series of images, analyzes, and processes them to generate the instructional videos. The technical effect of the automatic video tutorial creator system 116 is the ability to automate the creation of instructional videos, providing a visual and comprehensive guide for various step-by-step processes, such as how to use different beauty products, such as different shades of foundation, different shades of lipstick, different hair colors, different hair styles, different nail colors, different nail arts, and the like.

In accordance with an embodiment, the interactive system 102 is connected to a cloud server for real-time data tracking of the user 124 and replenishment tracking and facilitation of the one or more lifestyle products in the dispensing system 106. By tracking user data in real-time, the interactive system 102 can provide personalized recommendations to the user 124 based on facial attributes and environmental parameters. Additionally, the cloud server connection allows for efficient inventory management and replenishment of beauty products in the dispensing system 106, ensuring that users always have access to the recommended products. Overall, this feature enhances the functionality and effectiveness of the interactive system 102 (i.e., the human-less store system) by enabling real-time data tracking and efficient product management.

FIG. 1B is a diagram illustrating various exemplary components of a mirror device, in accordance with an embodiment of the present disclosure. FIG. 1B is described in conjunction with elements from FIG. 1A. With reference to FIG. 1B, there is shown a diagram 100B of the mirror device 104. In addition to the mirror surface 108, the mirror device 104 may include an image sensor 126, a Virtual Reality (VR) headset 128, an oxygen sensor 130, a pre-trained neural network module 132, a memory 134, a processor 136, a display apparatus 138, and a 3D printer 139. The processor 136 is communicatively coupled to each of the image sensor 126, the VR headset 128, the oxygen sensor 130, the pre-trained neural network module 132, the memory 134, the display apparatus 138, and the 3D printer 139.

The image sensor 126 may include suitable logic, circuitry, interfaces, and/or code that is configured to capture a sequence of images of the user 124 when the user 124 accesses the mirror device 104. The image sensor 126 may be configured to capture a live video feed of the user 124 for further analysis. The image sensor 126 may be referred to as a color camera sensor. Examples of the image sensor 126 may include, but are not limited to, a Video-See-Through (VST) color camera sensor, a Charge-Coupled Device (CCD) image sensor, a Complementary Metal-Oxide-Semiconductor (CMOS) image sensor, a Phase Detection Autofocus (PDAF) color camera sensor, and the like.

The VR headset 128 may be referred to as a head-mounted device that utilizes advanced technologies, such as motion tracking and stereoscopic displays, to create an immersive and interactive virtual reality experience for the user 124.

In accordance with an embodiment, the mirror device 104 further comprises the VR headset 128 configured to load and render a specific tutorial item depending on the selection of a lifestyle product of the one or more lifestyle products. The VR headset 128 interacts seamlessly with the mirror device 104, allowing the user 124 to virtually try out different beauty products and receive step-by-step tutorials on how to apply them. By integrating the VR headset 128 into the mirror device 104, the user 124 can visualize the effects of different beauty products in a realistic and immersive manner and can learn proper application techniques of different beauty products. The combination of the mirror device 104 and the VR headset 128 creates a synergistic effect, revolutionizing the way users engage with beauty products and enhancing their overall experience.

The oxygen sensor 130 may include suitable logic, circuitry, interfaces and/or code that is configured to perform a deep skin analysis of the user 124. In an implementation, the oxygen sensor 130 may be comprised by a hyperspectral camera. The hyperspectral camera is a type of imaging device that captures and processes information across a wide range of wavelengths within the electromagnetic spectrum. In the context of measuring oxygen levels, the hyperspectral camera likely uses specific spectral bands or wavelengths associated with the interaction between light and oxygen to derive relevant information to provide a more comprehensive and detailed analysis of oxygen-related data.

The pre-trained neural network module 132 may be referred to as a Deep Neural Network (DNN) module, such as a Convolution Neural Network (CNN) module, which is trained on a large dataset to perform a specific task, such as image recognition or natural language processing.

In accordance with an embodiment, the mirror device 104 further comprises the pre-trained neural network module 132 configured to analyze the plurality of facial attributes of the user 124 and the plurality of environmental parameters and accordingly recommend the one or more lifestyle products to the user 124. The pre-trained neural network module 132 is specifically designed to analyze the various facial attributes of the user 124, such as skin type and conditions, and combines this information with external parameters like UV index, pollution index, and weather patterns. Additionally, the pre-trained neural network module 132 takes into account any allergies that the user 124 may have to certain products. By integrating and processing this diverse set of data, the pre-trained neural network module 132 generates personalized recommendations for the one or more beauty products. The pre-trained neural network module 132 has the ability to analyze and interpret such complex inputs and to provide tailored suggestions that cater to the unique needs and preferences of each user.

In accordance with an embodiment, the pre-trained neural network module 132 is trained using a dataset in combination with one or more of: an image segmentation operation, a color analysis operation, a pattern recognition operation, a skin analysis operation, and a facial recognition operation. The pre-trained neural network module 132 is trained on a large dataset comprising analysis a number of images of different users in different environmental conditions as well with different facial features. Various machine learning and computer vision techniques, such as image segmentation, the color analysis, the pattern recognition, the skin analysis, and the facial recognition are used to extract the plurality of facial features of the user 124 under different environmental conditions. The pre-trained neural network module 132 may also be referred to as an Artificial Intelligence (AI) module.

The memory 134 may include suitable logic, circuitry, interfaces, and/or code that is configured to store machine code and/or instructions executable by the processor 136. Examples of implementation of the memory 134 may include, but are not limited to, a Solid-State Drive (SSD), an Electrically Erasable Programmable Read-Only Memory (EEPROM), Random Access Memory (RAM), Read Only Memory (ROM), Hard Disk Drive (HDD), Flash memory, a Secure Digital (SD) card, a computer-readable storage medium, and/or CPU cache memory. The memory 134 may be configured to store user experiences and types of user inputs. The memory 134 may store an operating system and/or a computer program product to operate the mirror device 104. A computer-readable storage medium for providing a non-transient memory may include, but is not limited to, an electronic storage device, a magnetic storage device, an optical storage device, an electromagnetic storage device, a semiconductor storage device, or any suitable combination of the foregoing. In FIG. 1B, the pre-trained neural network module 132 lies outside the memory 134. In another implementation, the pre-trained neural network module 132 may be stored in the memory 134.

The processor 136 may include suitable logic, circuitry, interfaces, and/or code that is configured to execute the instructions stored in the memory 134. Examples of the processor 136 may include, but are not limited to, a system-on-module (SoM) processor, an integrated circuit, a co-processor, a microprocessor, a microcontroller, a complex instruction set computing (CISC) processor, an application-specific integrated circuit (ASIC) processor, a reduced instruction set (RISC) processor, a very long instruction word (VLIW) processor, a state machine, a data processing unit, and other processors or circuits. Moreover, the processor 136 may refer to one or more individual processors, processing devices, or a processing unit that is part of a machine.

The display apparatus 138 is integrated with the mirror device 104 for user interaction. The display apparatus 138 may comprise a user interface (UI) through which the user 124 may provide an input to the mirror device 104 and may receive an output from the mirror device 104. The display apparatus 138 may also be referred to as a display device. Examples of the display apparatus 138 may include but are not limited to, a Liquid Crystal Display (LCD) display apparatus, Light Emitting Diode (LED) display apparatus, a display screen, and the like. The size (e.g., 24 inches or 32 inches) of the display apparatus 138 may vary according to different application scenarios.

The 3D printer 139 may include suitable logic, circuitry, interfaces, and/or code that is configured to create a 3D object layer by layer from a digital model or computer-aided design (CAD) technique. The 3D printer 139 may be configured to provide a sample of an eyewear frame (or a 3D eyewear frame) to the user 124. The 3D printer 139 may be configured to use various materials, such as plastics, metals, ceramics, and the like. Moreover, the 3D printer 139 may be configured to provide a customized eyewear frame with precision and according to the user's requirements.

Furthermore, the mirror device 104 may also have a card reader and a QR code scanner. In addition to the aforementioned hardware components, the mirror device 104 may have the following software modules, such as a virtual makeup module, a foundation shade finder module, an AI skin analyzer module, a virtual hair color module, a virtual hair style module, a virtual nail art module, a virtual nail paint module, a virtual nail accessory module, a payment gateway module, an expert call module, and the like. Alternatively, the pre-trained neural network module 132 may be configured to act as any of the aforementioned software modules, depending on an application scenario. The virtual makeup module includes real-time makeup applications, which provide unparalleled experience across Windows, iPhone operating systems (iOS), and Android ecosystems. Moreover, the mirror device 104 does not require any internet connectivity to operate. Alternatively stated, the mirror device 104 may be used as a standalone device.

FIG. 1C is a network environment diagram of an interactive system, in accordance with an embodiment of the present disclosure. FIG. 1C is described in conjunction with elements from FIGS. 1A and 1B. With reference to FIG. 1C, there is shown a network environment diagram 100C that comprises the interactive system 102 (of FIG. 1A), a cloud server 140, and a communication network 142.

Examples of the cloud server 140 may include, but are not limited to, an application server, a storage server, an Internet-of-Things (IoT) server, or a combination thereof. Moreover, the cloud server 140 may either be a single hardware server or a plurality of hardware servers operating in a parallel or distributed architecture for real-time data tracking of the user 124 and replenishment tracking and facilitation of the one or more beauty products in the dispensing system 106.

The communication network 142 may include suitable logic, circuitry, interfaces, and/or code that is configured to connect the interactive system 102 to the cloud server 140. Examples of the communication network 142 may include, but are not limited to, a cellular network (e.g., a 5G or 5G NR network, such as sub 6 GHz, cmWave, or mmWave communication network), a wireless sensor network (WSN), a cloud network, a Local Area Network (LAN), a vehicle-to-network (V2N) network, a Metropolitan Area Network (MAN), and/or Internet.

The interactive system 102 is connected to the cloud server 140 for various operations, such as for data collection between networked devices, replenishment of beauty products, including lifestyle and personal care products in the dispensing system 106, real-time data tracking of the user 124, which allows personalization and an enhanced level of responsiveness of the user 124 with machine learning operations, and the like. Moreover, various brands can monitor the sales performance in real-time frequency by virtue of getting an inventory alert from the dispensing system 106 and may send their staff members to replenish the dispensing system 106, resulting in seamless operation of the interactive system 102.

FIG. 2 is a diagram illustrating an exemplary implementation scenario of an interactive system, in accordance with an embodiment of the present disclosure. FIG. 2 is described in conjunction with elements from FIGS. 1A to 1C. With reference to FIG. 2, there is shown the interactive system 102 that comprises the mirror device 104 and the dispensing system 106.

The interactive system 102 may also be referred to as either an elevator vending machine with an integrated smart mirror, a human-less AI store, or a human-less beauty store that is configured to provide a personalized experience of one or more lifestyle products, including personal care and beauty products to a user (e.g., the user 124, not shown in FIG. 2) and recommend a product by use of a facial video of the user captured by the mirror device 104. Moreover, the interactive system 102 allows the user 124 to get the recommended product from the dispensing system 106 after a purchase on the go.

FIG. 3 is a diagram illustrating an integration of an interactive system with an eyewear recommendation system, in accordance with an embodiment of the present disclosure. FIG. 3 is described in conjunction with elements from FIGS. 1A-1C and 2. With reference to FIG. 3, there is shown a diagram 300 that depicts an integration of the interactive system 102 comprising the mirror device 104 and the dispensing system 106 with the eyewear recommendation system 110. There is further shown a user 302 wearing the VR headset 128 (of FIG. 1B).

In accordance with an embodiment, the interactive system 102 further comprises the eyewear recommendation system 110 configured to recommend a three-dimensional (3D) eyewear frame to the user 302 based on two or more of: an emotional index of the user 302, gaze metrics of the user 302, a facial jawline of the user 302, an eye shape, a type of nose of the user 302, a context communicated by the user 302, and an intent and preferences of the user 302, wherein the recommended 3D eyewear frame is provided to the user 302 in a physical form. The interactive system 102, along with the eyewear recommendation system 110, enables a virtual try-on the experience of a 3D eyewear, where the user 302 may virtually try multiple eyewear frames and then may get a sample print of the recommended 3D eyewear frame with adjusted dimensions depending on the facial shape of the user 302. The recommended 3D eyewear frame may be printed by use of the 3D printer 139 and may be provided to the user 302 resulting in an enhanced user experience. The eyewear recommendation system 110 may be configured to recommend an eyewear or an eyewear frame (e.g., a 3D eyewear frame) to the user 302 based on an emotional index of the user 302. The emotional index of the user 302 is computed based on the facial attributes of the user 302. The facial attributes of the user 302 may include face shape, skin tone, hairstyle of the user 302, and different shapes and sizes of eyes (e.g., almond-shaped eyes, round eyes, upturned eyes, downturned eyes, hooded eyes, monolid eyes, deep-set eyes, close-set eyes, wide-set eyes, prominent eyes, and the like), different shapes of nose, detection of nose-types and its effect on selection of eyewear, and facial jawline, and the like. The computed emotional index is used to identify the user's emotions, the preferences, and needs of the user 302. Typically, an eyewear recommendation system comprises an image sensor for capturing an image of a user, a facial recognition module for recognizing the user's face in the captured image, an emotional index determination module for determining an emotional index of the user based on the user's facial attributes, a recommendation module for recommending one or more eyewear frames to the user based on the determined emotional index and also a database of different eyewear and associated emotional indexes. The choice of eyewear may be affected by different gaze metrics of the user 302, such as gaze direction and gaze duration of the user 302. Therefore, the eyewear recommendation system may also comprise a gaze detection module for determining the user's gaze direction and gaze duration. The eyewear recommendation system 110 enables the user 302 to check how the recommended eyewear would look on him/her.

When a style or a type of nose is identified, a facial landmark model typically focuses on the shape and position of the nose bridge and tip. For example, the facial landmark model may identify a low or a flat bridge as a sign of a “narrow” nose, while a prominent or hooked nose as a “prominent” nose. The facial landmark model may also take into account the shape and position of nostrils and the overall size and proportion of the nose in relation to the rest of the face. There are many different ways to classify the shape and style of the nose, a few common categories include: narrow: a nose that is thin or narrow in width, often with a low or flat bridge; prominent: a nose that stands out or is prominent on the face, often with a high or hooked bridge; wide: a nose that is wide or broad in width, often with flared nostrils; straight: a nose that has a straight or symmetrical shape, with a straight bridge and a straight or slightly curved tip; turned up: a nose that has a downward curved tip; roman: a nose that has a slight bump on the bridge and a straight or slightly upturned tip; Greek: a nose that has a high bridge and a sharp downward curve at the tip, and the like. Moreover, the facial landmark model may also identify the under-eye circles and determine the eyelid position, crease detection, size of the iris, distance between the inner and outer corners, brow position to skull to perfectly identify the shape of the eyes, and the like, to determine the most suitable eyewear for the user 302.

Furthermore, the facial jawline also affects the appearance of the eyewear. In an example, a person with a strong jawline may choose an eyewear that complements his/her facial features. An eyewear with bold or angular frames may emphasize the strong jawline, while a round or oval eyewear may soften the strong jawline. In another example, a person with a less strong jawline may choose an eyewear that can create an illusion of a strong jawline. An eyewear with strong and angular frames may create the appearance of the strong jawline, while an eyewear with round or delicate frames may make the jawline to appear less prominent.

In addition to the emotional index of the user 302, gaze metrics of the user 302, the facial jawline of the user 302, the eye shape of the user 302, the type of nose of the user 302, the eyewear recommendation system 110 also considers the context communicated by the user 302, the intent and preferences communicated by the user 302 for recommending the 3D eyewear frame to the user 302. For instance, in a case, the user 302 is on vacation and wants to enjoy beach areas in such a case, the eyewear recommendation system 110 is configured to analyze the context and intent of the user 302 and accordingly, recommend the eyewear frame to the user 302. In another case, the user 302 is going to attend a professional meeting and wearing a formal dress then, the eyewear recommendation system 110 is configured to analyze the context and intent of the user 302 and accordingly, recommend the eyewear frame to the user 302. This way, the eyewear recommendation system 110 enables a personalized user experience by recommending the eyewear frame to the user 302 by analyzing the aforementioned parameters in real time or near real time.

In another implementation scenario, the interactive system 102 may be integrated with the hairstyle recommendation system 118. The hairstyle recommendation system 118 may be configured to recommend a specific custom hairstyle to the user 302 based on an emotional index of the user 302, a skin tone of the user 302, a forehead length, a neck length of the user 302, an eye color of the user 302, a face size parameter of the user 124 and a type of face parameter of the user 302. The hairstyle recommendation system 118 may be configured to assess various facial features of the user 302, including face shape, skin tone, forehead and neck length, eye color, lip color, skin tone, and hair color. Moreover, such information about the features is then processed to suggest hairstyles that best suit the user's unique characteristics, considering factors such as face shape, hair color, skin tone, and the like. The hairstyle recommendation system 118 may incorporate a database of hairstyles, detailing their suitability for different features ensuring tailored recommendations that align with individual preferences of each user. The hairstyle recommendation system 118 may be used to recognize the user's face shape and recommend hairstyles that would flatter their specific face shape, such as oval, round, square, diamond, heart, pear, or oblong face, along with the hair color of the user 302, such as blonde, brunette, or red, and the like. Additionally, the hairstyle recommendation system 118 may be used to recognize the skin tone and lip color of the user to recommend hairstyles that would flatter the user's skin tone and lip color of the user 302. The hairstyle recommendation system 118 may be configured to recommend different hairstyles that would balance out a round face or different hairstyles that would highlight a person's unique eye color. The hairstyle recommendation system 118 would be able to provide personalized and tailored hairstyle recommendations that adapt to the user's individual needs and preferences. In an implementation, the hairstyle recommendation system 118 may comprise an image capturing device (e.g., a camera or a smart phone) to capture an image of the user 302. Thereafter, computer vision techniques such as, facial recognition, image segmentation, and the like, are used to identify the user's face, skin tone, forehead and neck length as well as size and type of face of the user 302. Additionally, the hairstyle recommendation system 118 also considers the context communicated by the user 302, the intent and preferences of the user 302 for recommending the best suitable hairstyle to the user 302. The hairstyle recommendation system 118 may also comprise an emotional index determination module which uses facial recognition technique to detect the user's facial expression and determine the emotional index of the user 302. After determining the emotional index of the user 302, various machine learning algorithms can be used to analyze the aforementioned parameters of the user 302 and recommend the most suitable hairstyle to the user 302 according to the user's face shape, skin tone, forehead and neck length, as well as size and type of face and the emotional index.

In a yet another implementation scenario, the interactive system 102 may be integrated with the makeup recommendation system 120. In accordance with an embodiment, the interactive system 102 further comprises the makeup recommendation system 120 may be configured to recommend at least one makeup product to the user 302 based on a combined analysis of the plurality of facial attributes of the user 302, a plurality of ambient factors around the user 302, a context communicated by the user 302, an intent and preferences of the user 302, an activity level of the user 302, and an allergic consideration of the user 302. Since, the makeup recommendation system 120 is integrated with the interactive system 102, the makeup recommendation system 120 operates in conjunction with the mirror device 104. Alternatively stated, the makeup recommendation system 120 operates in conjunction with the pre-trained neural network module 132. The makeup recommendation system 120 may be configured to recommend the at least one makeup product to the user 302 based on aforementioned parameters of the user 302 along with the use of the pre-trained neural network module 132 which is trained on a dataset along with the various computer vision techniques, such as image segmentation, color analysis, pattern recognition, and the like. The makeup recommendation system 120 may comprise a software application named, “virtual try-on” which enables an end customer to see end results of applying one or more makeup products on their face via augmented reality and computer vision. The simulated environment enables the end customer to identify the best fit for their makeup requirements. The software application analyzes and identifies key points on the face using a custom face detection and landmark identification system. The virtual map of the face once constructed is subsequently overlaid with the effects of a makeup product try-on. The overlay operation is also aided by a live tracking and shading mechanism that delivers a seamless live video experience for the end customer. The makeup recommendation system can be deployed via multiple channels including a mobile application, a web application, and also, on a native smart mirror kiosk.

Simulating a virtual makeup try-on requires the analysis of a combination of facial and ambient factors as make-up products interact with various global parameters to produce a very specific look in different scenarios. The facial features of the user 302 are also analyzed. The multiple patches of skin are analyzed to identify the skin type, color and texture of skin. Various algorithms, such as image segmentation, color analysis, and pattern recognition are used to identify and classify different types of skin conditions and to recommend the appropriate makeup products and techniques that can best conceal or enhance the identified skin conditions. The make-up products themselves lend the features of color and texture to the overlaying process. For example, lipsticks come in matte finish as well as glossy finish among others. These types require different overlay techniques and produce a completely different look for the end user. The analysis of various facial features in a video feed of the user 302 allows the makeup recommendation system 120 to get a feature list for the skin type and skin quality of the user 302. The various skin properties like the type of skin, quality, any deformities like dark circles etc., can be identified This rich understanding of the user's facial features coupled with the virtual try-on usage history and purchase history at the current or sister stores helps the makeup recommendation system 120 to identify best fit products to recommend. This makes the makeup recommendation system 120 to not only support the user 302 to try on make-up products but also considers a host of features derived during the try-on process and the user's behavior to best identify product recommendations for the user 302. 6. Moreover, the makeup recommendation system 120 offers a one click beautification option that instantly transforms user's face from just a raw selfie input image. The makeup recommendation system 120 smoothen down the user's face, remove any kind of imperfections and blemishes from the user's face, even before the user 302 selects a shade from any category for the try on experience. The makeup recommendation system 120 may be configured to analyze the existing skin tone, the eye-color, lip-color, the hair color, and the user's face, which supports in making the makeup recommendation system 120 more advanced recommendation system.

When applying the makeup product, there are several parameters to consider in order to achieve the desired look: 1) skin type: the different skin types have different preferences and require different types of makeup. For example, people with oily skin may prefer to use oil-free or matte products to control shine, while people with dry skin may prefer to use moisturizing products to keep their skin hydrated. 2) Skin tone: the different skin tones require different shades of makeup. Furthermore, the use of right foundation and concealer shades is also required that match the skin tone of the user 302 to avoid looking ashy or unnatural. 3) Face shape: the shape of user's face can affect the way that makeup looks on the user 302, for example, people with round faces may want to use contouring techniques to create the illusion of a more angular face shape, while people with square faces may want to use blush to soften their features. 4) Eye shape: the different eye shapes can be accentuated or downplayed with makeup, for example, people with hooded or almond-shaped eyes may want to use eyeliner and mascara to create the appearance of larger eyes, while people with deep-set eyes may want to use light colored eyeshadow to bring their eyes forward. Moreover, the makeup recommendation system 120 may be integrated with a smart dispensing system which may be configured to dispense out the right amount of makeup product to reduce the wastage and ensures that the product lasts longer.

Furthermore, the makeup recommendation system 120 may be configured to analyze the plurality of ambient factors, such as light illumination levels, humidity levels, and the like. 1) Lighting: the type and intensity of lighting can affect the way that makeup looks, therefore, it is required to apply makeup in natural light or in a well-lit area to ensure that the colors and textures are accurate. Additionally, it is required to consider the lighting of the event or environment the user in, as different lighting can make makeup look different. 2) Camera flash: If an end customer is taking photographs, the end customer should consider how the makeup will look under flash photography. Some makeup products can cause a “flashback” effect, where it appears white in photographs. To avoid this, the end customer can use flash-friendly makeup or apply a flash-friendly setting powder. 3) Climate and humidity: the weather and humidity can affect how makeup wears throughout the day. In hot and humid weather, makeup may melt or slide off, so it is required to use long-lasting, waterproof products. In cold and dry weather, skin can become dry, so it is required to use moisturizing products and to keep skin hydrated. 4) Allergies and sensitivities: Some people have sensitive skin or allergies to certain ingredients in makeup. It is required to check the ingredients in makeup products and to do a patch test on a small area of skin before applying makeup to ensure that it doesn't cause any allergic reactions or skin irritation. 5) Activity level of the user: If the user is doing a lot of physical activity, it is required to choose makeup products that are long-lasting and would not smudge or rub off easily. Additionally, it's required to consider how the makeup will look after sweating or movement. 6) Professional or personal look: If the user is going to a formal event, job interview or meeting it is required to choose makeup that is professional and appropriate for the occasion. On the other hand, if the user is going to a party or a casual event, the user can choose a more dramatic or playful look. That is how, the makeup recommendation system 120 also considers the context, intent and preferences of the user 302 while recommending the makeup product the user 302.

In addition to aforementioned factors, the makeup recommendation system 120 may be configured to analyze the emotional index of the user 302, gaze metrics of the user 302, the facial jawline of the user 302, the eye shape of the user 302 and the type of nose of the user 302 while recommending the makeup product to the user 302.

In accordance with an embodiment, the interactive system 102 further comprises the skincare recommendation system 122 configured to recommend at least one skincare product to the user based on: an analysis of an image of the facial portion of the user 302 captured at different wavelengths using a multisensory device, one or more visible and invisible skin attributes of the user 302, a plurality of interactive user inputs, where the plurality of interactive user inputs comprises two or more of: genetic information of the user 302, a medical history of the user 302, a water intake amount of the user 302, a diet of the user 302, a stress level of the user 302, and a sleep quality indicator of the user 302, a presence of one or more active ingredients in one or more skincare products and a plurality of ambient factors around the user 302, where the plurality of ambient factors comprises two or more of: a light illumination level, a humidity level, a spatial light distribution, and a temperature in surroundings of the user 302. The skincare recommendation system 122 may be configured to perform a detailed analysis of various skin features (i.e., uneven skin tone, dark spots, fine lines, and wrinkles, skin dullness, skin firmness, skin hydration, skin smoothness, oxygen level of skin, dark circle, overall skin health score, acne, eye wrinkles, skin redness, crow's feet, texture, hyperpigmentation, and the like) of the user 302. The various skin features are divided into three categories based on their positive, negative, and neutral impact on the skin of the user 302. This allows the skincare recommendation system 122 to focus on fortifying the positive aspects of the user 302 while also considering the user's dermatological requirements in aspects with negative overall impact like crow's feet or wrinkles.

The multisensory device may be configured to capture the image of the facial portion of the user 302 in a wide range of wavelengths and detect color temperature and intensity of ambient light. The multisensory device may also be configured to detect the spectral characteristics of any artificial light source that is present to enhance the output of skin analysis or identify the facial attributes in a deeper sense.

In accordance with an embodiment, the analysis of the image of the facial portion of the user 302 captured at different wavelengths further comprises calibrating and correcting any distortion present in the captured image in real time and further analyze the one or more visible and invisible skin attributes of the user 302. The skincare recommendation system 122 may be configured to analyze the skin attributes that are directly visible from naked eye, such as spurts of acne, dark spots, and the like, as well as the invisible skin attributes, which are not the most obvious to the naked eye, such as oxygenation, hydration, firmness, and the like. Thus, the skincare recommendation system 122 performs a deeper analysis of the skin surface keeping in account the ambient environment parameters like lighting, camera contrast, noise, etc. These factors lead to normalize the texture driven assessment of the skin and hence, enables the skincare recommendation system 122 to perform a more holistic and correct analysis.

Furthermore, the skincare recommendation system 122 may be configured to utilize a user input questionnaire that dynamically updates for each individual user experience. The questionnaire starts with identifying some pre-analysis questions that help to set a baseline, like gender, age, etc. to contextualize the outcomes and assist in better understanding of the skin parameters for the user 302. The pre-trained neural network module 132 may be configured to analyze the questionnaire and provide the possible outcomes. After questionnaire assessment, the scores are allotted to the user on the various parameters that define the subsequent questions to be asked from the user 302. These questions can be asked to reaffirm pressing issues that are identified by the pre-trained neural network module 132 as well as to get a deeper understanding on the user baselines. It has been observed that the effect of both physical and mental health can be seen on the skin of the user 302 as a lot of implicit human behaviors contributes to the quality of the skin. This might include overt factors like the lack of sleep or more layered aspects like the level of stress or a sedentary lifestyle that might be indirectly causing a lack of vitamin-D. An expertly designed questionnaire not only tries to smartly identify the aforementioned features but also does it without seeming tedious and overly intrusive for the user 302. The questions are interwoven with the user story, so as to ensure maximum information gain while not compromising on the user experience with the skincare product. Moreover, the skincare recommendation system 122 may be configured to analyze the plurality of interactive user inputs, which include genetics of the user 302, medical history of the user 302, diet, water intake, smoking habits, known allergies, alcohol habits, sleep quality, stress levels, time spent in front of electronic screens, or sun exposure. The skincare recommendation system 122 can also be integrated with inventory management (ERP) solutions to account for product availability at different levels. This could be applied to brick-and-mortar stores as well as online marketplaces to ensure that the user 302 is recommended the best fit products that are easily available thus, maximizing the conversion rate for the overall recommendation system.

Furthermore, the skincare recommendation system 122 may be configured to analyze the plurality of ambient factors around the user 302 which may also affect the selection of the skincare product. The various ambient factors are 1) lighting: the type and intensity of lighting can affect the way that makeup looks, therefore, it is required to apply makeup in natural light or in a well-lit area to ensure that the colors and textures are accurate. Additionally, it is required to consider the lighting of the event or environment the user 302 in, as different lighting can make skin look different. 2) Allergies and sensitivities: some people have sensitive skin or allergies to certain ingredients in skincare products then, it is required to check the ingredients in makeup products and to do a patch test on a small area of skin before applying makeup to ensure that it doesn't cause any allergic reactions or skin irritation. 3) Stress and emotion index: the use of biometric and Remote Photoplethysmography (RPPG) signals to measure physiological stress indicators such as heart rate, skin temperature, and perspiration, as well as emotional indicators such as facial expressions or voice analysis to detect the user's stress and emotion levels. This will impact the skin health wherein dullness and uneven skin tone will be present and hence, low oxygen score, resulting in stress marks, early wrinkles and under eyes circles. The emotional index associated with the user 302 may comprise capturing an image of the user, a facial recognition module for recognizing the user's face in the captured image, an emotional index determination module for determining the emotional index of the user 302 based on the user's facial expression, a recommendation module for recommending skincare to the user 302 based on the determined emotional index. The basic classification of skin type and relevant ingredients may dictate the combination of makeup categories therefore, it is required to be part of the skincare recommendation system 122. The different classification of skincare products may include natural, ayurveda, scientific, chemical free, vegan etc.

Moreover, the skincare recommendation system 122 may be configured to perform the deep facial skin analysis. The number of images of the facial portion (i.e., human face) of the user 302 are captured, which are calibrated and corrected against the image distortions in real-time using parallel processing. A multi-modal approach utilizing various machine learning (ML) algorithms and the hyper-spectral domain is used either independently or in conjunction with each other for the detection of various skin issues, such as dark circles, dark spots, uneven skin tone, skin dullness, firmness, hydration score, eye wrinkles, oxygen score, redness, hyperpigmentation, and the like. For example, a Gabor filter, Gray Level Co-occurrence Matrix (GLCM), adaptive gaussian filter and CLAHE are used for the detection of features in the hyper spectral domain. Also, the captured image of the facial portion of the user 302 is normalized at a preprocessing stage using Fast Fourier Transform (FFT) and wavelet transforms, and finding anisotropic exposure heatmap to get the consistent scores of skin issues. The multi-modal approach utilizing ML algorithms and hyper-spectral domain considers a temporal sequence of images of skin that would result from differences, such as lighting conditions, focal lengths, and camera angles caused by different conditions under which a time series of such images can be captured. Based on the detected skin issues, genetics, medical history, lifestyle habits, diet, and the like of the user, the skincare recommendation system 122 is updated in order to recommend the most suitable beauty and skin care product to the user 302. Additionally, the skincare recommendation system 122 is used to monitor the changes in the morphology, color, and the texture of the skin over the time, including skin tone, blemishes, wrinkles, and the like, that are used to monitor and track the effectiveness and working of the skin care products, which is applied on the skin.

Furthermore, the multi-modal approach utilizing ML algorithms also considers the various environmental factors, such as UV rays, pollution index, humidity index, and the like. The considered environmental factors are correlated with skin issues like uneven skin tone, hydration score, skin dullness, wrinkles, pigmentation, etc. Thus, the skincare recommendation system 122 not only considers the various skin issues but also considers the impact of the environmental factors on various skin issues and accordingly recommends the most suitable beauty and skin care product to the user. Additionally, the multi-modal approach utilizing ML algorithms considers the face segmentation in different regions in order to obtain an enhanced accuracy in the determination of aforementioned skin issues. The face segmentation includes cheeks, under eyes, chin, jawline, forehead, crow's regions, mustache region, face normalization including shadow neutralization, skin tone neutralization, light neutralization, skin parameters detection (e.g., image transformation in a hyperspectral domain, image segmentation, deep learning based patch classification, local spatial analysis and adaptive thresholding, texture, and multi-directional edge-based analysis, and the like) and skin intensity calculation (e.g., deep learning based score estimation, local and global mean, variance, skewness and kurtosis, correlation between gender, age), and the like. The skincare recommendation system 122, during deep facial skin analysis, categorizes skin features into positive, neutral, and negative impacts to fortify positive aspects and address concerns, such as crow's feet or wrinkles. Thereafter, a user input questionnaire based on individual experiences is initiated with baseline questions in order to identify pertinent features of the user accurately without intrusiveness.

FIG. 4 is a diagram illustrating an integration of an interactive system with a dynamic product formulation system, in accordance with an embodiment of the present disclosure. FIG. 4 is described in conjunction with elements from FIGS. 1A-1C, 2, and 3. With reference to FIG. 4, there is shown a diagram 400 that depicts an integration of the interactive system 102 comprising the mirror device 104 and the dispensing system 106 with the dynamic product formulation system 112.

The interactive system 102 comprises the dynamic product formulation system 112 in addition to the mirror device 104, the dispensing system 106, and the physical try-on unit 114. In accordance with an embodiment, the interactive system 102 further includes the dynamic product formulation system 112 configured to formulate in a real-time or near real-time a customized product and dispense out the formulated customized product for the user 302 based on an analysis of a plurality of physiological parameters and an activity level of the user 302. The dynamic product formulation system 112 is configured to offer a high degree of personalization. Every individual has unique physiological characteristics (e.g., heart rate, blood pressure, skin temperature, respiration rate, pupil dilation, and the like) and preferences, and the dynamic product formulation system 112 aims to cater to those differences by creating customized products. The dynamic product formulation system 112 is configured to collect and analyze a range of physiological data from the user 302, such as heart rate and skin temperature, after considering the user's ongoing activities. For example, if the user is engaged in physical exercise, the dynamic product formulation system 112 might formulate a more sweat-resistant makeup product. Thereafter, the dispensing system 106 is configured to dispense the newly created product, ready for immediate use by the user 302. In an implementation, the dynamic product formulation system 112 may be attached to the mirror device 104 and the dispensing system 106. In accordance with an embodiment, the dynamic product formulation system 112 is equipped with a sensing device to measure the plurality of physiological parameters and the activity level of the user 302, wherein the plurality of physiological parameters comprises a heart rate, a skin tone, a skin color, a skin temperature, and an emotion index. The dynamic product formulation system 112 may be equipped with a sensing device (e.g., Remote Photoplethysmography, RPPG), which is configured to communicate with the user's smartphone and analyze the user's behavior based on physiological data, such as heart rate and skin temperature, emotion index, lip style detector, and the like. The dynamic product formulation system 112 also considers the time of the day, external weather as well as activity information to dispense out the customized product for the user 302. The dynamic product formulation system 112 may be referred to as a smart lipstick dispenser or a smart foundation dispenser. Consequently, the dynamic product formulation system 112 is configured to adjust the color of customized product (e.g., lipstick), accordingly, providing a unique and personalized experience to the user 302.

FIG. 5 is a diagram illustrating an integration of an interactive system with a physical try-on unit, in accordance with an embodiment of the present disclosure. FIG. 5 is described in conjunction with elements from FIGS. 1A-1C, 2, 3, and 4. With reference to FIG. 5, there is shown a diagram 500 that depicts an integration of the interactive system 102 comprising the mirror device 104 and the dispensing system 106 with the physical try-on unit 114.

The interactive system 102 comprises the physical try-on unit 114 in addition to the mirror device 104 and the dispensing system 106. The mirror device 104 may also be used as a customized foundation bar or a foundation shade finder. The interactive system 102 enables a foundation purchase by use of an AI shade finder module, where the user 302 may find the right shade of a foundation product that will look natural with the skin tone of the user 302. The physical try-on unit 114 enables the user 302 to physically try the foundation product recommended by the makeup recommendation system 120.

In an implementation, the interactive system 102 further comprising the physical try-on unit 114 configured to form a user-specific visualization indicative of a lifestyle product visually discernible to be worn by the user 302 or applied to a body portion of the user 302 depending on a type of lifestyle product on the physical try-on unit 114. The physical try-on unit 114 is configured to provide a more accurate visualization of how a lifestyle product would look on the user 302, considering their unique features and body shape thereby, helping the user 302 to make better decisions. The physical try-on unit 114 works by creating a user-specific visualization, such as by taking into account the user's body features, shape, and personal style preferences to generate a tailored representation of the lifestyle product. Furthermore, the generated visualization is dependent on the type of lifestyle product being considered. The real-time or the near real-time experience provided by the physical try-on unit 114 is used to allow rapid rendering to ensure a seamless and responsive interaction that enhances the accuracy of personalization. As a result, by offering a realistic visualization, the physical try-on unit 114 facilitates more informed decision-making for the user 302 that can lead to increased user satisfaction and potentially lower product returns, as the user 302 have a more clearer understanding of how a product will fit into the user's lifestyle.

Each of the eyewear recommendation system 110, the dynamic product formulation system 112, the physical try-on unit 114, the automatic video tutorial creator system 116, the hairstyle recommendation system 118, the makeup recommendation system 120 and the skincare recommendation system 122 may be used either as separate units or in conjunction with the mirror device 104.

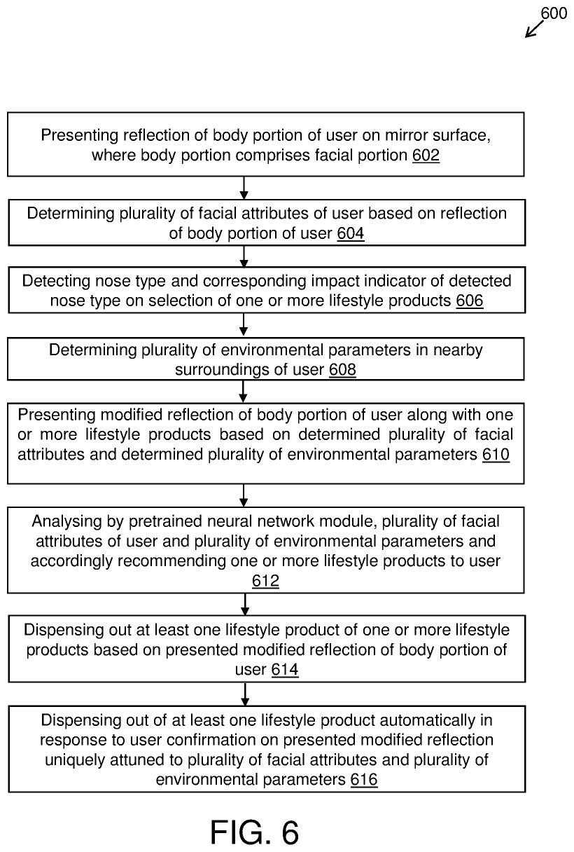

FIG. 6 is a diagram illustrating a flowchart of a method for recommending one or more lifestyle products, in accordance with an embodiment of the present disclosure. FIG. 6 is described in conjunction with elements from FIGS. 1A-1C, 2, 3, 4, and 5. With reference to FIG. 6, there is shown a method 600 that includes operations 602 to 616. The interactive system 102 (of FIG. 1A) is configured to execute the method 600.

There is provided the method 600 for recommending one or more lifestyle products. At 602, the method 600 includes presenting a reflection of the body portion of a user, where the body portion comprises a facial portion of the user. For example, when the user 124 visits the interactive system 102 (i.e., the human-less store), and the user 124 uses the mirror device 104, the mirror surface 108 comprised by the mirror device 104 presents the reflection of the body portion of the user 124 when the user 124 comes in front of the mirror surface 108. The body portion of the user 124 includes the facial portion which includes various pointers, such as hair, eyes, lips, and cheeks of the user 124. The primary function of the mirror device 104 is to capture a frontal selfie of the user's face (i.e., the face of the user 124) and to process and enhance the required image information in order to present an accurate representation of the facial portion of the user 124.

At 604, the method 600 includes determining a plurality of facial attributes of the user 124 based on the reflection of the body portion of the user 124. The facial attributes may include skin concerns, such as wrinkles, eye bags, crows-feet, redness, uneven skin, dryness of skin, flaky skin, and the like. The facial attributes may also include the hair textures of the user 124.

At 606, the method 600 includes detecting a nose type and a corresponding impact indicator of the detected nose type on selection of the one or more lifestyle products by the mirror device 104. Moreover, the plurality of facial attributes further comprises the detected nose type and the corresponding impact indicator.

At 608, the method 600 includes determining a plurality of environmental parameters in nearby surroundings of the user 124. The environmental parameters play a significant role in determining the appropriate skincare products and routines for the user 124. The determination of the facial attributes of the user 124 along with the determination of the environmental parameters in nearby surroundings of the user 124 ensures that the recommended one or more beauty or skincare products meet the user's individual requirements and enhance the effectiveness and relevance of the recommended product.

At 610, the method 600 includes presenting a modified reflection of the body portion of the user 124 along with the one or more lifestyle products based on the determined plurality of facial attributes and the determined plurality of environmental parameters. The determined facial attributes of the user 124 and the external environmental parameters in nearby surroundings of the user 124 are analyzed collectively along with consideration of any allergy of the user 124 towards certain chemicals, such as paraben or sulphate, and the like. The modified reflection comprises at least a change in a facial feature of the user 124 when the one or more lifestyle products is to be used by the user 124.

At 612, the method 600 further includes analyzing by the pre-trained neural network module 132, the plurality of facial attributes of the user 124 and the plurality of environmental parameters and accordingly recommend the one or more lifestyle products to the user 124.

At 614, the method 600 includes dispensing out at least one lifestyle product of the one or more lifestyle products based on the presented modified reflection of the body portion of the user 124. In an implementation, the method 600 further includes formulating in a real-time or near real-time a customized product by a dynamic product formulation system and dispensing out the formulated customized product for the user 124 based on an analysis of a plurality of physiological parameters and an activity level of the user 124.

At 616, the method 600 includes dispensing out at least one lifestyle product automatically in response to the user confirmation on the presented modified reflection uniquely attuned to the plurality of facial attributes and the plurality of environmental parameters.

The method 600 is used to recommend the one or more lifestyle products (including beauty and personal care products) with enhanced reliability by analyzing the health parameters of the user, such as facial attributes, an eye color, a hair color, a hair style, skin attributes including skin texture of the user, acne, dark spots, etc., and also, analyzing the impact of environmental parameters on the health of the user 124, such as weather of a particular region, Ultra-Violet (UV) index, pollution index, and the like.

The operations 602 to 616 are only illustrative and other alternatives can also be provided where one or more operations are added, one or more steps are removed, or one or more operations are provided in a different sequence without departing from the scope of the claims herein.

In one aspect, the present disclosure provides a computer program product comprising program instructions for performing the method 600, when executed by one or more processors. In a yet another aspect, the present disclosure provides a non-transitory computer-readable storage medium comprising instructions which, when executed by a computer, cause the computer to carry out the method 600 of training and operating a neural network model for recommending one or more lifestyle products.

While various embodiments described in the present disclosure have been described above, it should be understood that they have been presented by way of example, and not limitation. It is to be understood that various changes in form and detail can be made therein without departing from the scope of the present disclosure. In addition to using hardware (e.g., within or coupled to control circuitry, a central processing unit (“CPU”), microprocessor, micro controller, digital signal processor, processor core, system on chip (“SOC”) or any other device), implementations may also be embodied in software (e.g. computer readable code, program code, and/or instructions disposed in any form, such as source, object or machine language) disposed for example in a non-transitory computer-readable medium configured to store the software. Such software can enable, for example, the function, fabrication, modeling, simulation, description, and/or testing of the apparatus and methods described herein. Such software can be disposed of in any known non-transitory computer-readable medium, such as a semiconductor, magnetic disc, or optical disc (e.g., CD-ROM, DVD-ROM, etc.). The software can also be disposed of as computer data embodied in a non-transitory computer-readable transmission medium (e.g., solid state memory or any other non-transitory medium including digital, optical, analog-based medium, such as removable storage media). Embodiments of the present disclosure may include methods of providing the apparatus described herein by providing software describing the apparatus and subsequently transmitting the software as a computer data signal over a communication network including the internet and intranets.

It is to be further understood that the system (i.e., the camera apparatus) described herein may be included in a semiconductor intellectual property core, such as a microcontroller (e.g., embodied in HDL), and transformed to hardware in the production of integrated circuits. Additionally, the system (i.e., the camera apparatus) described herein may be embodied as a combination of hardware and software. Thus, the present disclosure should not be limited by any of the above-described exemplary embodiments but should be defined only in accordance with the following claims and their equivalents.

What is claimed is:

1. An interactive system, comprising:
a mirror device that comprises a mirror surface, wherein the mirror device is configured to:
present a reflection of a body portion of a user on the mirror surface, wherein the body portion comprises a facial portion;
determine a plurality of facial attributes of the user based on the reflection of the body portion of the user;
determine a plurality of environmental parameters in nearby surroundings of the user; and
present a modified reflection of the body portion of the user on the mirror surface along with one or more lifestyle products based on the determined plurality of facial attributes and the determined plurality of environmental parameters; and
a dispensing system connected to the mirror device configured to dispense out at least one lifestyle product of the one or more lifestyle products based on the presented modified reflection on the mirror device.

2. The interactive system according to claim 1, wherein the plurality of facial attributes comprises two or more of: a face shape, one or more skin attributes, a hairstyle, a unique user-specific eye shape, a user-specific eye size, a user-specific nose shape, a nose type, and a facial jawline.

3. The interactive system according to claim 2, wherein the mirror device is further configured to detect a nose type and a corresponding impact indicator of the detected nose type on selection of the one or more lifestyle products, and wherein the plurality of facial attributes further comprises the detected nose type and the corresponding impact indicator.

4. The interactive system according to claim 1, wherein the plurality of environmental parameters comprises one or more of: a weather in a geographical location of the mirror device, a pollution level, an Ultraviolet (UV) index, a time of the day, and a humidity level of the geographical location.

5. The interactive system according to claim 1, wherein the dispense out of the at least one lifestyle product is performed automatically in response to a user confirmation on the presented modified reflection uniquely attuned to the plurality of facial attributes and the plurality of environmental parameters.

6. The interactive system according to claim 1, wherein the modified reflection comprises at least a change in a facial feature of the user when the one or more lifestyle products is to be used by the user.

7. The interactive system according to claim 1, further comprises an eyewear recommendation system configured to recommend a three-dimensional (3D) eyewear frame to the user based on two or more of: an emotional index of the user, gaze metrics of the user, a facial jawline of the user, an eye shape, a type of nose of the user, a context communicated by the user, and an intent and preferences of the user, wherein the recommended 3D eyewear frame is provided to the user in a physical form.

8. The interactive system according to claim 1, further comprising a dynamic product formulation system configured to formulate in a real time or near real time a customized product and dispense out the formulated customized product for the user based on an analysis of a plurality of physiological parameters and an activity level of the user.

9. The interactive system according to claim 8, the dynamic product formulation system is equipped with a sensing device to measure the plurality of physiological parameters and the activity level of the user, wherein the plurality of physiological parameters comprises a heart rate, a skin tone, a skin color, a skin temperature, and an emotion index.

10. The interactive system according to claim 1, further comprising a physical try-on unit configured to form a user-specific visualization indicative of a lifestyle product visually discernible to be worn by the user or applied to a body portion of the user depending on a type of lifestyle product on the physical try-on unit.

11. The interactive system according to claim 1, further comprising an automatic video tutorial creator system configured to generate instructional videos from a series of images that depict a step-by-step process for using the one or more lifestyle products.

12. The interactive system according to claim 1, further comprising a hairstyle recommendation system configured to recommend a specific custom hairstyle to the user based on an emotional index of the user, a skin tone, a forehead length, a neck length, an eye color, a face size parameter and a type of face parameter of the user.

13. The interactive system according to claim 1, further comprising a makeup recommendation system configured to recommend at least one makeup product to the user based on a combined analysis of the plurality of facial attributes of the user, a plurality of ambient factors around the user, a context communicated by the user, an intent and preferences of the user, an activity level of the user, and an allergic consideration of the user.

14. The interactive system according to claim 1, further comprising a skincare recommendation system configured to recommend at least one skincare product to the user based on:
an analysis of an image of the facial portion of the user captured at different wavelengths using a multisensory device;
one or more visible and invisible skin attributes of the user;
a plurality of interactive user inputs, wherein the plurality of interactive user inputs comprises two or more of: genetic information of the user, a medical history of the user, a water intake amount of the user, a diet of the user, a stress level of the user, and a sleep quality indicator of the user;
a presence of one or more active ingredients in one or more skincare products; and
a plurality of ambient factors around the user wherein, the plurality of ambient factors comprises two or more of: a light illumination level, a humidity level, a spatial light distribution, and a temperature in surroundings of the user.

15. The interactive system according to claim 14, wherein the analysis of the image of the facial portion of the user captured at different wavelengths further comprises calibrating and correcting any distortion present in the captured image in real time and further analyse the one or more visible and invisible skin attributes of the user.

16. The interactive system according to claim 1, wherein the mirror device further comprises a pretrained neural network module configured to analyse the plurality of facial attributes of the user and the plurality of environmental parameters and accordingly recommend the one or more lifestyle products to the user.

17. The interactive system according to claim 16, wherein the pretrained neural network module is trained using a dataset in combination with one or more of: an image segmentation operation, a color analysis operation, a pattern recognition operation, a skin analysis operation, and a facial recognition operation.

18. The interactive system according to claim 1, wherein the mirror device further comprises a Virtual Reality (VR) headset configured to load and render a specific tutorial item depending on the selection of a lifestyle product of the one or more lifestyle products.

19. The interactive system according to claim 1, wherein the interactive system is connected to a cloud server for real-time data tracking of the user and replenishment tracking and facilitation of the one or more lifestyle products in the dispensing system.

20. A method for recommending one or more lifestyle products, the method comprising:
presenting a reflection of a body portion of a user, wherein the body portion comprises a facial portion;
determining a plurality of facial attributes of the user based on the reflection of the body portion of the user;
determining a plurality of environmental parameters in nearby surroundings of the user;
presenting a modified reflection of the body portion of the user along with the one or more lifestyle products based on the determined plurality of facial attributes and the determined plurality of environmental parameters; and
dispensing out at least one lifestyle product of the one or more lifestyle products based on the presented modified reflection of the body portion of the user.
